(19) United States
(12) Patent Application Publication
(10) Pub. No.: US 2025/0128696 A1
(43) Pub. Date: Apr. 24, 2025

(54) COORDINATED SUSPENSION AND PROPULSION CONTROL FOR A VEHICLE

(71) Applicant: GM Global Technology Operations LLC, Detroit, MI (US)

(72) Inventors: Paul G. Otanez, Franklin, MI (US); Juchirl Park, Troy, MI (US); Stuart Walter Parker, Ann Arbor, MI (US)

(21) Appl. No.: 18/489,215

(22) Filed: Oct. 18, 2023

(51) Int. Cl. B60W 30/02; B60W 10/22; B60W 50/00

(52) U.S. Cl. CPC B60W 30/02; B60W 10/22; B60W 50/0097; B60W 2400/00; B60W 2520/06; B60W 2556/10; B60W 2710/22

(57) ABSTRACT

A system for control of a vehicle includes a plurality of vehicle actuators in electrical communication with a controller. The controller is programmed to determine a predicted path of the vehicle. The controller is further programmed to determine one or more vehicle level control parameters based at least in part on the predicted path of the vehicle. The one or more vehicle level control parameters includes a vehicle level suspension control parameter and a vehicle level motion control parameter. The controller is further programmed to adjust an operation of one or more suspension actuators of the plurality of vehicle actuators based at least in part on the vehicle level suspension control parameter. The controller is further programmed to adjust an operation of one or more motion actuators of the plurality of vehicle actuators based at least in part on the vehicle level motion control parameter.

### INTRODUCTION

The present disclosure relates to systems and methods for control of a vehicle, and more particularly, to systems and methods for coordinated suspension and propulsion control for a vehicle.

To increase occupant comfort and convenience, vehicles may be equipped with electronically controlled suspension and propulsion systems which are configured to adapt ride and handling characteristics of the vehicle based on environmental conditions. Electronically controlled suspension systems may include, for example, hydraulic actuators, electromagnetic actuators, electromechanical actuators, pneumatic actuators, and/or the like. Electronically controlled propulsion systems may include, for example, electric drive motors, internal combustion engines, electrically controlled braking systems, electric power steering systems, and/or the like. However, current electronically controlled suspension and propulsion systems may not account for additional factors which may affect occupant experience. For example, current electronically controlled suspension and propulsion systems may be adjusted based on current, detected road conditions, and may not account for future environmental conditions. Additionally, current electronically controlled suspension and propulsion systems may be adjusted independently, without coordination between the suspension and propulsion systems.

Thus, while electronically controlled suspension and propulsion systems and methods achieve their intended purpose, there is a need for a new and improved system and method for control of a vehicle.

### SUMMARY

According to several aspects, a system for control of a vehicle is provided. The system may include a plurality of vehicle actuators and a controller in electrical communication with the plurality of vehicle actuators. The controller is programmed to determine a predicted path of the vehicle. The controller is further programmed to determine one or more vehicle level control parameters based at least in part on the predicted path of the vehicle. The one or more vehicle level control parameters includes a vehicle level suspension control parameter and a vehicle level motion control parameter. The controller is further programmed to adjust an operation of one or more suspension actuators of the plurality of vehicle actuators based at least in part on the vehicle level suspension control parameter. The controller is further programmed to adjust an operation of one or more motion actuators of the plurality of vehicle actuators based at least in part on the vehicle level motion control parameter.

In another aspect of the present disclosure, to determine the predicted path of the vehicle, the controller is further programmed to determine the predicted path based at least in part on actions of an occupant of the vehicle.

In another aspect of the present disclosure, the system further may include a plurality of vehicle sensors and an automated driving system in electrical communication with the controller. To determine the predicted path of the vehicle, the controller is further programmed to perform a plurality of measurements of an environment surrounding the vehicle using the plurality of vehicle sensors. To determine the predicted path of the vehicle, the controller is further programmed to determine the predicted path of the vehicle using the automated driving system based at least in part on the plurality of measurements. The predicted path of the vehicle includes at least a location of the vehicle as a function of time.

In another aspect of the present disclosure, the vehicle level suspension control parameter includes at least one of: a stiffness mode, a driving mode, a ride height mode, and a load-leveling mode. The vehicle level motion control parameter includes at least one of: a propulsion setting and a steering setting.

In another aspect of the present disclosure, to adjust the operation of the one or more suspension actuators, the controller is further programmed to adjust at least one of one or more suspension actuation settings using the one or more suspension actuators based at least in part on the vehicle level suspension control parameter. The one or more suspension actuation settings includes at least one of: a per-wheel damping force, a per-wheel spring force, a per-wheel ride height, a per-wheel travel, and a sway bar stiffness.

In another aspect of the present disclosure, to adjust the operation of the one or more motion actuators, the controller is further programmed to adjust at least one of one or more motion actuation settings using the one or more motion actuators based at least in part on the vehicle level motion control parameter. The one or more motion actuation settings includes at least one of: a per-wheel drive torque, a per-wheel steering torque, and a per-wheel brake force.

In another aspect of the present disclosure, to adjust the operation of the one or more suspension actuators, the controller is further programmed to adjust at least one of the one or more suspension actuation settings using the one or more suspension actuators based at least in part on the vehicle level suspension control parameter and the one or more motion actuation settings.

In another aspect of the present disclosure, to adjust the operation of the one or more motion actuators, the controller is further programmed to adjust at least one of the one or more motion actuation settings using the one or more motion actuators based at least in part on the vehicle level motion control parameter and the one or more suspension actuation settings.

In another aspect of the present disclosure, the system further may include a plurality of vehicle sensors in electrical communication with the controller. The controller is further programmed to measure a current value of the one or more suspension actuation settings using the plurality of vehicle sensors. The controller is further programmed to measure a current value of the one or more motion actuation settings using the plurality of vehicle sensors. The controller is further programmed to determine the one or more vehicle level control parameters based at least in part on the current value of the one or more suspension actuation settings and the current value of the one or more motion actuation settings.

In another aspect of the present disclosure, the controller is further programmed to determine a suspension actuator capability range for each of the one or more suspension actuators. The controller is further programmed to determine a motion actuator capability range for each of the one or more motion actuators. The controller is further programmed to determine the one or more vehicle level control parameters based at least in part on suspension actuator capability range for each of the one or more suspension actuators and the motion actuator capability range for each of the one or more motion actuators.

According to several aspects, a method for control of a vehicle is provided. The method may include determining a predicted path of the vehicle. The method further may include determining one or more vehicle level control parameters based at least in part on the predicted path of the vehicle. The one or more vehicle level control parameters includes: a vehicle level suspension control parameter and a vehicle level motion control parameter. The method further may include adjusting an operation of one or more suspension actuators based at least in part on the vehicle level suspension control parameter. The method further may include adjusting an operation of one or more motion actuators based at least in part on the vehicle level motion control parameter.

In another aspect of the present disclosure, determining the one or more vehicle level control parameters further may include determining the vehicle level suspension control parameter. The vehicle level suspension control parameter includes at least one of: a stiffness mode, a driving mode, a ride height mode, and a load-leveling mode. Determining the one or more vehicle level control parameters further may include determining the vehicle level motion control parameter. The vehicle level motion control parameter includes at least one of: a propulsion setting and a steering setting.

In another aspect of the present disclosure, adjusting the operation of the one or more suspension actuators further may include adjusting at least one of one or more suspension actuation settings using the one or more suspension actuators based at least in part on the vehicle level suspension control parameter. The one or more suspension actuation settings includes at least one of: a per-wheel damping force, a per-wheel spring force, a per-wheel ride height, a per-wheel travel, and a sway bar stiffness.

In another aspect of the present disclosure, adjusting the operation of the one or more motion actuators further may include adjusting at least one of one or more motion actuation settings using the one or more motion actuators based at least in part on the vehicle level motion control parameter. The one or more motion actuation settings includes at least one of: a per-wheel drive torque, a per-wheel steering torque, and a per-wheel brake force.

In another aspect of the present disclosure, adjusting the operation of the one or more suspension actuators further may include adjusting at least one of the one or more suspension actuation settings using the one or more suspension actuators based at least in part on the vehicle level suspension control parameter and the one or more motion actuation settings.

In another aspect of the present disclosure, adjusting the operation of the one or more motion actuators further may include adjusting at least one of the one or more motion actuation settings using the one or more motion actuators based at least in part on the vehicle level motion control parameter and the one or more suspension actuation settings.

In another aspect of the present disclosure, the method further may include determining a suspension actuator capability range for each of the one or more suspension actuators. The method further may include determining a motion actuator capability range for each of the one or more motion actuators. The method further may include determining the one or more vehicle level control parameters based at least in part on suspension actuator capability range for each of the one or more suspension actuators and the motion actuator capability range for each of the one or more motion actuators.

According to several aspects, a system for control of a vehicle is provided. The system may include a suspension actuator, a motion actuator, and a controller in electrical communication with the suspension actuator and the motion actuator. The controller is programmed to determine a predicted path of the vehicle based at least in part on actions of an occupant of the vehicle. The controller is further programmed to determine a vehicle level suspension control parameter based at least in part on the predicted path of the vehicle. The controller is further programmed to determine a vehicle level motion control parameter based at least in part on the predicted path of the vehicle. The controller is further programmed to adjust at least one of one or more suspension actuation settings using the suspension actuator based at least in part on the vehicle level suspension control parameter. The one or more suspension actuation settings includes at least one of: a per-wheel damping force, a per-wheel spring force, a per-wheel ride height, a per-wheel travel, and a sway bar stiffness. The controller is further programmed to adjust at least one of one or more motion actuation settings using the motion actuator based at least in part on the vehicle level motion control parameter. The one or more motion actuation settings includes at least one of: a per-wheel drive torque, a per-wheel steering torque, and a per-wheel brake force.

In another aspect of the present disclosure, the controller is further programmed to adjust at least one of the one or more suspension actuation settings using the suspension actuator based at least in part on the vehicle level suspension control parameter and the one or more motion actuation settings. The controller is further programmed to adjust at least one of the one or more motion actuation settings using the motion actuator based at least in part on the vehicle level motion control parameter and the one or more suspension actuation settings.

In another aspect of the present disclosure, the system further may include a plurality of vehicle sensors in electrical communication with the controller. The controller is further programmed to measure a current value of the one or more suspension actuation settings using the plurality of vehicle sensors. The controller is further programmed to measure a current value of the one or more motion actuation settings using the plurality of vehicle sensors. The controller is further programmed to determine the vehicle level suspension control parameter and the vehicle level motion control parameter based at least in part on the current value of the one or more suspension actuation settings and the current value of the one or more motion actuation settings.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for control of a vehicle, according to an exemplary embodiment;

FIG. 2 is a flowchart of a method for control of a vehicle, according to an exemplary embodiment; and

FIG. 3 is a schematic diagram of an exemplary software architecture for performing the method for control of the vehicle, according to an exemplary embodiment.

### DETAILED DESCRIPTION

The following description is merely exemplary in nature and is not intended to limit the present disclosure, application, or uses.

Vehicles may be equipped with electronically controlled suspension and propulsion systems. It may be advantageous to adjust a behavior of the suspension and propulsion systems based on past, present, or predicted future driving conditions. Adjustments to either the suspension system or the propulsion system may affect a performance of the other system. Calculation of vehicle dynamics for adjustment of suspension and propulsion systems may be complex and resource intensive. Therefore, the present disclosure provides a new and improved system and method for control of a vehicle allowing for computationally efficient coordinated suspension and propulsion system control.

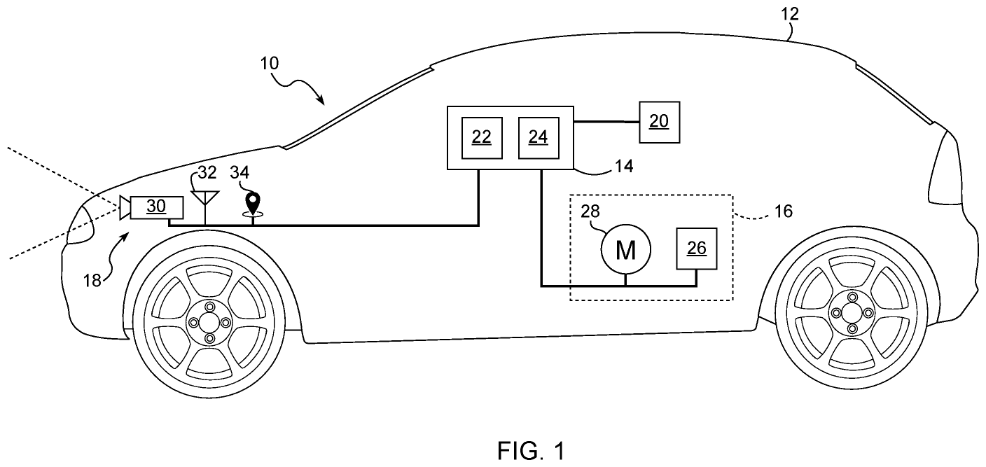

Referring to FIG. 1, a system for control of a vehicle is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. The system 10 generally includes a controller 14, a plurality of vehicle actuators 16, a plurality of vehicle sensors 18, and an automated driving system 20.

The controller 14 is used to implement a method 100 for control of a vehicle, as will be described below. The controller 14 includes at least one processor 22 and a non-transitory computer readable storage device or media 24. The processor 22 may be a custom made or commercially available processor, a central processing unit (CPU), a graphics processing unit (GPU), an auxiliary processor among several processors associated with the controller 14, a semiconductor-based microprocessor (in the form of a microchip or chip set), a macroprocessor, a combination thereof, or generally a device for executing instructions. The computer readable storage device or media 24 may include volatile and nonvolatile storage in read-only memory (ROM), random-access memory (RAM), and keep-alive memory (KAM), for example. KAM is a persistent or non-volatile memory that may be used to store various operating variables while the processor 22 is powered down. The computer-readable storage device or media 24 may be implemented using a number of memory devices such as PROMs (programmable read-only memory), EPROMS (electrically PROM), EEPROMs (electrically erasable PROM), flash memory, or another electric, magnetic, optical, or combination memory devices capable of storing data, some of which represent executable instructions, used by the controller 14 to control various systems of the vehicle 12. The controller 14 may also consist of multiple controllers which are in electrical communication with each other. The controller 14 may be inter-connected with additional systems and/or controllers of the vehicle 12, allowing the controller 14 to access data such as, for example, speed, acceleration, braking, and steering angle of the vehicle 12.

The controller 14 is in electrical communication with the plurality of vehicle actuators 16, the plurality of vehicle sensors 18, and the automated driving system 20. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the controller 14 are within the scope of the present disclosure.

The plurality of vehicle actuators 16 are used to adjust handling characteristics of the vehicle 12. The plurality of vehicle actuators 16 includes at least one suspension actuator 26 and at least one motion actuator 28. It should be understood that the plurality of vehicle actuators 16 may include additional actuators without departing from the scope of the present disclosure. The plurality of vehicle actuators 16 are in electrical communication with the controller 14 as described above.

The suspension actuator 26 is used to control an operation of a suspension of the vehicle 12. The suspension actuator 26 adjusts suspension actuation settings. In the scope of the present disclosure, the suspension actuation settings include, for example, a per-wheel damping force, a per-wheel spring force, a per-wheel ride height, a per-wheel travel, a sway bar stiffness, and/or the like. In an exemplary embodiment, the suspension actuator 26 is a hydraulic actuator operable to control a flow of a hydraulic fluid within suspension components (e.g., within a shock absorber). In another exemplary embodiment, the suspension actuator 26 is an electromagnetic actuator operable to produce magnetic fields which alter a viscosity of a fluid within suspension components. In another exemplary embodiment, the suspension actuator 26 is an electromechanical actuator operable to control a movement of mechanical components within the suspension of the vehicle 12. In another exemplary embodiment, the suspension actuator 26 is a pneumatic actuator operable to control an air pressure within suspension components (e.g., an air spring and/or an air shock). It should be understood that any electrically controllable actuator operable to adjust the suspension actuation settings is within the scope of the present disclosure. It should further be understood that the suspension actuator 26 may further include a plurality of actuators operating independently or in conjunction without departing from the scope of the present disclosure.

The motion actuator 28 is used to provide propulsion to move the vehicle 12, stop the vehicle 12, control a path of the vehicle 12, and/or otherwise influence an operation of a drivetrain of the vehicle 12. The motion actuator 28 adjusts motion actuation settings. In the scope of the present disclosure, the motion actuation settings include, for example, a per-wheel drive torque, a per-wheel steering torque, a per-wheel steering angle, a per-wheel brake force, and/or the like. In an exemplary embodiment, the motion actuator 28 is an electric drive motor. In another exemplary embodiment, the motion actuator 28 is an internal combustion engine. In another exemplary embodiment, the motion actuator 28 is a hybrid-electric drivetrain. In another exemplary embodiment, the motion actuator 28 is an electrically controlled braking system. In another exemplary embodiment, the motion actuator 28 is an electric power steering system. It should be understood that any electrically controllable actuator operable to adjust the motion actuation settings, including, for example, drive-by-wire systems (e.g., brake-by-wire, steer-by-wire, and/or the like) is within the scope of the present disclosure. It should further be understood that the motion actuator 28 may further include a plurality of actuators operating independently or in conjunction without departing from the scope of the present disclosure.

The plurality of vehicle sensors 18 are used to acquire information relevant to the vehicle 12. In an exemplary embodiment, the plurality of vehicle sensors 18 includes at least a camera system 30, a vehicle communication system 32, and a global navigation satellite system (GNSS) 34.

In another exemplary embodiment, the plurality of vehicle sensors 18 further includes sensors to determine performance data about the vehicle 12. In a non-limiting example, the plurality of vehicle sensors 18 further includes a motor speed sensor, a motor torque sensor, an electric drive motor voltage and/or current sensor, an accelerator pedal position sensor, a brake position sensor, a coolant temperature sensor, a cooling fan speed sensor, a transmission oil temperature sensor, a per-wheel damping force sensor, a per-wheel spring force sensor, a per-wheel ride height sensor, a per-wheel travel sensor, a sway bar stiffness sensor, a per-wheel drive torque sensor, a per-wheel steering torque sensor, and a per-wheel brake force sensor.

In another exemplary embodiment, the plurality of vehicle sensors 18 further includes sensors to determine information about an environment within the vehicle 12. In a non-limiting example, the plurality of vehicle sensors 18 further includes at least one of a seat occupancy sensor, a cabin air temperature sensor, a cabin motion detection sensor, a cabin camera, a cabin microphone, and/or the like.

In another exemplary embodiment, the plurality of vehicle sensors 18 further includes sensors to determine information about an environment surrounding the vehicle 12. In a non-limiting example, the plurality of vehicle sensors 18 further includes at least one of an ambient air temperature sensor, a barometric pressure sensor, and/or a photo and/or video camera which is positioned to view the environment in front of the vehicle 12.

In another exemplary embodiment, at least one of the plurality of vehicle sensors 18 is a perception sensor capable of perceiving objects and/or measuring distances in the environment surrounding the vehicle 12. In a non-limiting example, the plurality of vehicle sensors 18 includes a stereoscopic camera having distance measurement capabilities. In one example, at least one of the plurality of vehicle sensors 18 is affixed inside of the vehicle 12, for example, in a headliner of the vehicle 12, having a view through a windscreen of the vehicle 12. In another example, at least one of the plurality of vehicle sensors 18 is affixed outside of the vehicle 12, for example, on a roof of the vehicle 12, having a view of the environment surrounding the vehicle 12. It should be understood that various additional types of perception sensors, such as, for example, LiDAR sensors, ultrasonic ranging sensors, radar sensors, and/or time-of-flight sensors are within the scope of the present disclosure. The plurality of vehicle sensors 18 are in electrical communication with the controller 14 as discussed above.

The camera system 30 is a perception sensor used to capture images and/or videos of the environment surrounding the vehicle 12. In an exemplary embodiment, the camera system 30 includes a photo and/or video camera which is positioned to view the environment surrounding the vehicle 12. In a non-limiting example, the camera system 30 includes a camera affixed inside of the vehicle 12, for example, in a headliner of the vehicle 12, having a view through the windscreen. In another non-limiting example, the camera system 30 includes a camera affixed outside of the vehicle 12, for example, on a roof of the vehicle 12, having a view of the environment in front of the vehicle 12.

In another exemplary embodiment, the camera system 30 is a surround view camera system including a plurality of cameras (also known as satellite cameras) arranged to provide a view of the environment adjacent to all sides of the vehicle 12. In a non-limiting example, the camera system 30 includes a front-facing camera (mounted, for example, in a front grille of the vehicle 12), a rear-facing camera (mounted, for example, on a rear tailgate of the vehicle 12), and two side-facing cameras (mounted, for example, under each of two side-view mirrors of the vehicle 12). In another non-limiting example, the camera system 30 further includes an additional rear-view camera mounted near a center high mounted stop lamp of the vehicle 12.

It should be understood that camera systems having additional cameras and/or additional mounting locations are within the scope of the present disclosure. It should further be understood that cameras having various sensor types including, for example, charge-coupled device (CCD) sensors, complementary metal oxide semiconductor (CMOS) sensors, and/or high dynamic range (HDR) sensors are within the scope of the present disclosure. Furthermore, cameras having various lens types including, for example, wide-angle lenses and/or narrow-angle lenses are also within the scope of the present disclosure.

The vehicle communication system 32 is used by the controller 14 to communicate with other systems external to the vehicle 12. For example, the vehicle communication system 32 includes capabilities for communication with vehicles (“V2V” communication), infrastructure (“V2I” communication), remote systems at a remote call center (e.g., ON-STAR by GENERAL MOTORS) and/or personal devices. In general, the term vehicle-to-everything communication (“V2X” communication) refers to communication between the vehicle 12 and any remote system (e.g., vehicles, infrastructure, and/or remote systems). In certain embodiments, the vehicle communication system 32 is a wireless communication system configured to communicate via a wireless local area network (WLAN) using IEEE 802.11 standards or by using cellular data communication (e.g., using GSMA standards, such as, for example, SGP.02, SGP.22, SGP.32, and the like). Accordingly, the vehicle communication system 32 may further include an embedded universal integrated circuit card (eUICC) configured to store at least one cellular connectivity configuration profile, for example, an embedded subscriber identity module (eSIM) profile. The vehicle communication system 32 is further configured to communicate via a personal area network (e.g., BLUETOOTH), near-field communication (NFC), and/or any additional type of radiofrequency communication. However, additional or alternate communication methods, such as a dedicated short-range communications (DSRC) channel and/or mobile telecommunications protocols based on the 3rd Generation Partnership Project (3GPP) standards, are also considered within the scope of the present disclosure. DSRC channels refer to one-way or two-way short-range to medium-range wireless communication channels specifically designed for automotive use and a corresponding set of protocols and standards. The 3GPP refers to a partnership between several standards organizations which develop protocols and standards for mobile telecommunications. 3GPP standards are structured as “releases”. Thus, communication methods based on 3GPP release 14, 15, 16 and/or future 3GPP releases are considered within the scope of the present disclosure. Accordingly, the vehicle communication system 32 may include one or more antennas and/or communication transceivers for receiving and/or transmitting signals, such as cooperative sensing messages (CSMs). The vehicle communication system 32 is configured to wirelessly communicate information between the vehicle 12 and another vehicle. Further, the vehicle communication system 32 is configured to wirelessly communicate information between the vehicle 12 and infrastructure or other vehicles. It should be understood that the vehicle communication system 32 may be integrated with the controller 14 (e.g., on a same circuit board with the controller 14 or otherwise a part of the controller 14) without departing from the scope of the present disclosure.

The GNSS 34 is used to determine a geographical location of the vehicle 12. In an exemplary embodiment, the GNSS 34 is a global positioning system (GPS). In a non-limiting example, the GPS includes a GPS receiver antenna (not shown) and a GPS controller (not shown) in electrical communication with the GPS receiver antenna. The GPS receiver antenna receives signals from a plurality of satellites, and the GPS controller calculates the geographical location of the vehicle 12 based on the signals received by the GPS receiver antenna. In an exemplary embodiment, the GNSS 34 additionally includes a map. The map includes information about infrastructure such as municipality borders, roadways, railways, sidewalks, buildings, and the like. Therefore, the geographical location of the vehicle 12 is contextualized using the map information. In a non-limiting example, the map is retrieved from a remote source using a wireless connection. In another non-limiting example, the map is stored in a database of the GNSS 34. It should be understood that various additional types of satellite-based radionavigation systems, such as, for example, the Global Positioning System (GPS), Galileo, GLONASS, and the BeiDou Navigation Satellite System (BDS) are within the scope of the present disclosure. It should be understood that the GNSS 34 may be integrated with the controller 14 (e.g., on a same circuit board with the controller 14 or otherwise a part of the controller 14) without departing from the scope of the present disclosure.

The automated driving system 20 is used to provide assistance to the occupant to increase occupant awareness and/or control behavior of the vehicle 12. In the scope of the present disclosure, the automated driving system 20 encompasses systems which provide any level of assistance to the occupant (e.g., blind spot warning, lane departure warning, and/or the like) and systems which are capable of autonomously driving the vehicle 12 under some or all conditions (e.g., automated lane keeping, adaptive cruise control, fully autonomous driving, and/or the like). It should be understood that all levels of driving automation defined by, for example, SAE J3016 (i.e., SAE LEVEL 0, SAE LEVEL 1, SAE LEVEL 2, SAE LEVEL 3, SAE LEVEL 4, and SAE LEVEL 5) are within the scope of the present disclosure.

In an exemplary embodiment, the automated driving system 20 is configured to detect and/or receive information about the environment surrounding the vehicle 12 and process the information to provide assistance to the occupant. In some embodiments, the automated driving system 20 is a software module executed on the controller 14. In other embodiments, the automated driving system 20 includes a separate automated driving system controller, similar to the controller 14, capable of processing the information about the environment surrounding the vehicle 12. In an exemplary embodiment, the automated driving system 20 may operate in a manual operation mode, a partially automated operation mode, and a fully automated operation mode.

In the scope of the present disclosure, the manual operation mode means that the automated driving system 20 provides warnings or notifications to the occupant but does not intervene or control the vehicle 12 directly. In a non-limiting example, the automated driving system 20 receives information from the plurality of vehicle sensors 18. Using techniques such as, for example, computer vision, the automated driving system 20 understands the environment surrounding the vehicle 12 and provides assistance to the occupant. For example, if the automated driving system 20 identifies, based on data from the plurality of vehicle sensors 18, that the vehicle 12 is likely to collide with a remote vehicle, the automated driving system 20 may use a display to provide a warning to the occupant.

In the scope of the present disclosure, the partially automated operation mode means that the automated driving system 20 provides warnings or notifications to the occupant and may intervene or control the vehicle 12 directly in certain situations. In a non-limiting example, the automated driving system 20 is additionally in electrical communication with components of the vehicle 12 such as a brake system, a propulsion system, and/or a steering system of the vehicle 12, such that the automated driving system 20 may control the behavior of the vehicle 12. In a non-limiting example, the automated driving system 20 may control the behavior of the vehicle 12 by applying brakes of the vehicle 12 to avoid an imminent collision. In another non-limiting example, the automated driving system 20 may control the steering system of the vehicle 12 to provide an automated lane keeping feature. In another non-limiting example, the automated driving system 20 may control the brake system, propulsion system, and steering system of the vehicle 12 to temporarily drive the vehicle 12 towards a predetermined destination. However, intervention by the occupant may be required at any time. In an exemplary embodiment, the automated driving system 20 may include additional components such as, for example, an eye tracking device configured to monitor an attention level of the occupant and ensure that the occupant is prepared to take over control of the vehicle 12.

In the scope of the present disclosure, the fully automated operation mode means that the automated driving system 20 uses data from the plurality of vehicle sensors 18 to understand the environment and control the vehicle 12 to drive the vehicle 12 to a predetermined destination without a need for control or intervention by the occupant.

The automated driving system 20 operates using a path planning algorithm which is configured to generate a safe and efficient trajectory for the vehicle 12 to navigate in the environment surrounding the vehicle 12. In an exemplary embodiment, the path planning algorithm is a machine learning algorithm trained to output control signals for the vehicle 12 based on input data collected from the plurality of vehicle sensors 18. In another exemplary embodiment, the path planning algorithm is a deterministic algorithm which has been programmed to output control signals for the vehicle 12 based on data collected from the plurality of vehicle sensors 18.

In a non-limiting example, the path planning algorithm generates a sequence of waypoints or a continuous path that the vehicle 12 should follow to reach a destination while adhering to rules, regulations, and safety constraints. The sequence of waypoints or continuous path is generated based at least in part on a detailed map and a current state of the vehicle 12 (i.e., position, velocity, and orientation of the vehicle 12). The detailed map includes, for example, information about lane boundaries, road geometry, speed limits, traffic signs, and/or other relevant features. In an exemplary embodiment, the detailed map is stored in the media 24 of the controller 14 and/or on a remote database or server. In another exemplary embodiment, the path planning algorithm performs perception and mapping tasks to interpret data collected from the plurality of vehicle sensors 18 and create, update, and/or augment the detailed map.

It should be understood that the automated driving system 20 may include any software and/or hardware module configured to operate in the manual operation mode, the partially automated operation mode, or the fully automated operation mode as described above.

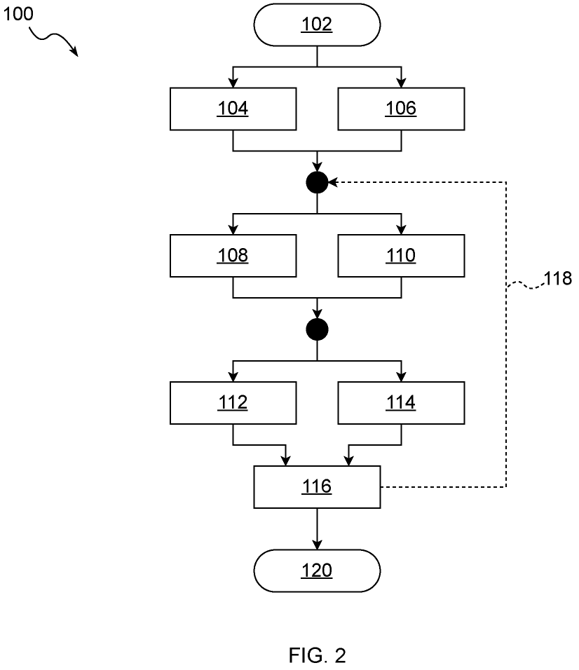

Referring to FIG. 2, a flowchart of the method 100 for control of a vehicle is shown. The method 100 begins at block 102 and proceeds to blocks 104 and 106. At block 104, the controller 14 determines a predicted path of the vehicle 12. In an exemplary embodiment, the predicted path is determined based at least in part on actions of the occupant of the vehicle 12. In a non-limiting example, the predicted path is determined based on a location of the vehicle 12 (as determined using the GNSS 34) and one or more control inputs (e.g., steering inputs, acceleration inputs, braking inputs, and/or the like) provided by the occupant. In another exemplary embodiment, the predicted path is determined using the automated driving system 20. In a non-limiting example, the controller 14 uses the plurality of vehicle sensors 18 to perform a plurality of measurements of the environment surrounding the vehicle 12. Based at least in part on the plurality of measurements, the automated driving system 20 uses the path planning algorithm (as discussed above) to determine the predicted path of the vehicle 12. In the scope of the present disclosure, the predicted path of the vehicle 12 includes at least a location of the vehicle 12 as a function of time (i.e., a predicted location of the vehicle 12 at one or more future points in time). It should be understood that various additional methods for determining the predicted path of the vehicle 12 are within the scope of the present disclosure. After block 104, the method 100 proceeds to blocks 108 and 110, as will be discussed in greater detail below.

At block 106, the controller 14 determines a suspension actuator capability range for the suspension actuator 26 and a motion actuator capability range for the motion actuator 28. In the scope of the present disclosure, the suspension actuator capability range quantifies a capability of the suspension actuator 26 to control the operation of the suspension of the vehicle 12. In a non-limiting example, the suspension actuator capability range includes at least one of: a minimum and maximum damping force, a minimum and maximum ride height, a minimum and maximum spring force, and/or the like. In the scope of the present disclosure, the motion actuator capability range quantifies a capability of the motion actuator 28. In a non-limiting example, the motion actuator capability range includes at least one of: a minimum and maximum acceleration rate, a minimum and maximum deceleration rate, a minimum and maximum steering torque, a minimum and maximum steering angle and/or the like. In an exemplary embodiment, the suspension actuator capability range and the motion actuator capability range are predetermined and are stored in the media 24 of the controller 14. In another exemplary embodiment, the controller 14 dynamically determines the suspension actuator capability range and the motion actuator capability range by communication with the suspension actuator 26 and the motion actuator 28, by communication with one or more distributed controllers (e.g., a body control module, a vehicle motion control module, a diagnostic module, and/or the like), and/or by communication with one or more software modules executed by the controller 14 and/or one or more distributed controllers (e.g., a body control software module, a vehicle motion control software module, a diagnostic software module, and/or the like). After block 106, the method 100 proceeds to blocks 108 and 110.

At block 108, the controller 14 determines a vehicle level suspension control parameter. In the scope of the present disclosure, a vehicle level control parameter is a control setpoint for one or more vehicle systems. In the scope of the present disclosure, the vehicle level suspension control parameter includes at least one of: a stiffness mode (e.g., economical, comfort, sport, and/or the like), a driving mode (e.g., track, highway, offroad, towing, and/or the like), a ride height mode (e.g., high ground clearance, entry/exit mode, and/or the like), a load-leveling mode (e.g., low payload, high payload, adaptive, and/or the like), and/or the like. In an exemplary embodiment, the vehicle level suspension control parameter is determined based at least in part on the predicted path of the vehicle 12 determined at block 104. For example, the vehicle level suspension control parameter may be adjusted based on a road type (e.g., highway, city street, unimproved road, and/or the like) along the predicted path of the vehicle 12. The vehicle level suspension control parameter is further determined based at least in part on the suspension actuator capability range determined at block 106 and feedback from measurements, as will be discussed in greater detail below. In another exemplary embodiment, the vehicle level suspension control parameter is determined based at least in part on future predicted conditions, as will be discussed in greater detail below. After block 108, the method 100 proceeds to blocks 112 and 114, as will be discussed in greater detail below.

At block 110, the controller 14 determines a vehicle level motion control parameter. In the scope of the present disclosure, the vehicle level motion control parameter includes at least one of: a propulsion setting (e.g., an acceleration rate, a brake force, and/or the like), a steering setting (e.g., a steering angle, a steering torque, and/or the like), and/or the like. In an exemplary embodiment, the vehicle level motion control parameter is determined based at least in part on the predicted path of the vehicle 12 determined at block 104. For example, the vehicle level motion control parameter may be adjusted based on a road grade (e.g., uphill, downhill, grade percentage, and/or the like) along the predicted path of the vehicle 12. The vehicle level motion control parameter is further determined based at least in part on the motion actuator capability range determined at block 106 and feedback from measurements, as will be discussed in greater detail below. In another exemplary embodiment, the vehicle level motion control parameter is determined based at least in part on future predicted conditions, as will be discussed in greater detail below. After block 110, the method 100 proceeds to blocks 112 and 114, as will be discussed in greater detail below.

At block 112, the controller 14 uses the suspension actuator 26 to adjust at least one of the suspension actuation settings. As discussed above, in the scope of the present disclosure, the suspension actuation settings include, for example, a per-wheel damping force, a per-wheel spring force, a per-wheel ride height, a per-wheel travel, a sway bar stiffness, and/or the like. In an exemplary embodiment, the suspension actuation settings are adjusted based at least in part on the vehicle level suspension control parameter determined at block 108. For example, if the driving mode is the track mode, the suspension actuator 26 is used to lower the per-wheel ride height and increase the per-wheel damping force. After block 112, the method 100 proceeds to block 116, as will be discussed in greater detail below.

At block 114, the controller 14 uses the motion actuator 28 to adjust at least one of the motion actuation settings. As discussed above, in the scope of the present disclosure, the motion actuation settings include, for example, a per-wheel drive torque, a per-wheel steering torque, a per-wheel brake force, and/or the like. In an exemplary embodiment, the motion actuation settings are adjusted based at least in part on the vehicle level motion control parameter determined at block 110. For example, if the vehicle level motion control parameter calls for a predetermined acceleration rate, the motion actuator 28 adjusts the per-wheel drive torque according to vehicle loading and traction conditions to achieve the predetermined acceleration rate. After block 114, the method 100 proceeds to block 116, as will be discussed in greater detail below.

In another exemplary embodiment, the suspension actuation settings are adjusted based at least in part on the motion actuation settings. For example, if the motion actuation settings call for a large braking force, the suspension actuation settings may be adjusted to increase suspension stiffness (e.g., by increasing per-wheel damping force) such that the vehicle 12 remains stable during braking. In another exemplary embodiment, the motion actuation settings are adjusted based at least in part on the suspension actuation settings. For example, if the suspension actuation settings call for an increased travel distance for a particular wheel of the vehicle 12 (e.g., such that the particular wheel may gain traction on uneven terrain), the motion actuation settings may be adjusted to increase drive torque to the particular wheel.

At block 116, the controller 14 uses the plurality of vehicle sensors 18 to measure a current value of one or more of the suspension actuation settings and a current value of one or more of the motion actuation settings. The current value of one or more of the suspension actuation settings may include, for example, a measured per-wheel damping force, a measured per-wheel spring force, a measured per-wheel ride height, a measured per-wheel travel, a measured per-wheel normal force, a measured sway bar stiffness, and/or the like. The current value of one or more of the motion actuation settings may include, for example, a measured per-wheel drive torque, a measured per-wheel steering torque, a measured per-wheel brake force, and/or the like. The current value of one or more of the suspension actuation settings and the current value of one or more of the motion actuation settings are provided as feedback for use in the determination of the vehicle level suspension control parameter at block 108 and the vehicle level motion control parameter at block 110, as indicated by the dashed arrow 118. For example, if a measured per-wheel drive torque of a particular wheel is relatively low, the vehicle level suspension control parameter may be adjusted to allow increased travel of the particular wheel such that traction is gained.

In an exemplary embodiment, the measurements performed by the plurality of vehicle sensors 18 are additionally used to predict future conditions of the vehicle 12, including, for example, a predicted future per-wheel damping force, a predicted future per-wheel spring force, a predicted future per-wheel ride height, a predicted future per-wheel travel, a predicted future per-wheel normal force, a predicted future sway bar stiffness, a predicted future per-wheel drive torque, a predicted future per-wheel steering torque, a predicted future lateral movement, a predicted future yaw rate, a predicted future per-wheel brake force, and/or the like. The predicted future conditions of the vehicle 12 are provided as feedback for use in the determination of the vehicle level suspension control parameter at block 108 and the vehicle level motion control parameter at block 110, as indicated by the dashed arrow 118. After block 116, the method 100 proceeds to enter a standby state at block 120.

In an exemplary embodiment, the controller 14 repeatedly exits the standby state 120 and restarts the method 100 at block 102. In a non-limiting example, the controller 14 exits the standby state 120 and restarts the method 100 on a timer, for example, every three hundred milliseconds.

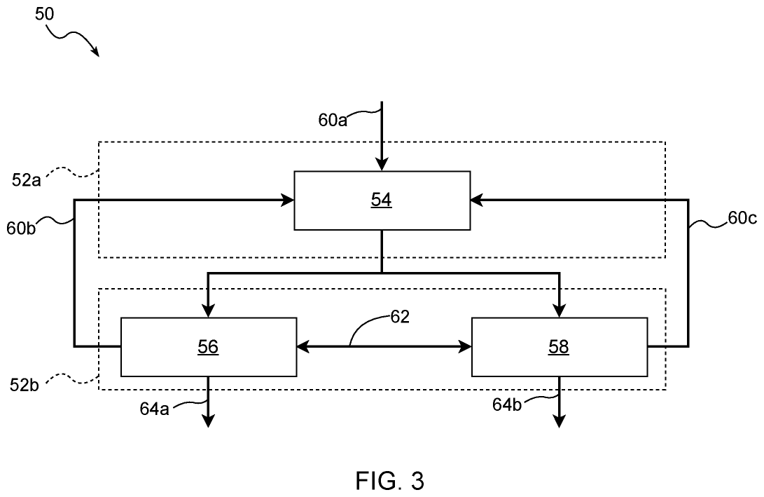

Referring to FIG. 3, a schematic diagram of an exemplary software architecture 50 for the performing the method 100 using the system 10 is shown. As discussed above, in an exemplary embodiment, the method 100 is executed using the system 10. In a non-limiting example, the controller 14 is configured with a set of computer-executable instructions (i.e., a computer program) to execute the method 100. The set of computer-executable instructions may be written according to any programming paradigm, including, for example, a functional programming paradigm, an imperative programming paradigm, an object-oriented programming paradigm, and/or the like. Furthermore, the set of computer-executable instructions may be written using any computer programming language.

The exemplary software architecture 50 is an example of an organizational structure for the set of computer-executable instructions. The exemplary software architecture 50 includes multiple software modules. In the scope of the present disclosure, software modules represent independent software components which are capable of receiving input data, performing operations on the input data according to computer-executable instructions, storing intermediate values (i.e., variables), and providing output data. In a non-limiting example, the software modules are programmatically implemented as functions, methods, subprograms, subroutines, and/or the like. In an exemplary embodiment, one or more of the software modules is configured to run in a non-blocking manner, meaning that failure or suspension of any one software module does not cause failure or suspension of any other software module. In a non-limiting example, one or more of the software modules are executed concurrently on separate threads of the controller 14. In another non-limiting example, one or more of the software modules are executed on separate controllers distributed throughout the vehicle 12.

Referring again to FIG. 3, the exemplary software architecture 50 includes a vehicle level abstraction layer 52a and an actuator supervisory abstraction layer 52b. In the scope of the present disclosure, software modules in the vehicle level abstraction layer 52a are responsible for high-level (i.e., vehicle level) control of vehicle behavior (e.g., ride comfort mode, acceleration of the vehicle 12, yaw of the vehicle 12, steering direction of the vehicle 12, and/or the like). In the scope of the present disclosure, software modules in the actuator supervisory abstraction layer 52b are responsible for low-level (i.e., actuator level) control of the plurality of vehicle actuators 16. In an exemplary embodiment, software modules in the vehicle level abstraction layer 52a are executed with a lower frequency than software modules in the actuator supervisory abstraction layer 52b.

In the exemplary software architecture 50, the vehicle level abstraction layer 52a includes a coordinator module 54. The actuator supervisory abstraction layer 52b includes a suspension control module 56 and a vehicle motion control (VMC) module 58. The coordinator module 54 is configured to determine the vehicle level control parameters (i.e., the vehicle level suspension control parameter and the vehicle level motion control parameter, as discussed above in reference to blocks 108 and 110 of the method 100). The coordinator module 54 receives a first input 60a, a second input 60b, and a third input 60c. The first input 60a is the predicted path of the vehicle 12 as discussed above in reference to block 104 of the method 100. The second input 60b is feedback from the suspension control module 56 as discussed above in reference to block 116 of the method 100. The third input 60c is feedback from the VMC module 58 as discussed above in reference to block 116 of the method 100. The vehicle level control parameters are determined based at least in part on the first input 60a, the second input 60b, and the third input 60c. The coordinator module 54 provides the vehicle level control parameters to the suspension control module 56 and the VMC module 58, as will be discussed in greater detail below.

The suspension control module 56 is configured to control the suspension actuator 26 to adjust at least one of the suspension actuation settings, as discussed above in reference to block 112 of the method 100. The suspension control module 56 receives the vehicle level control parameters produced by the coordinator module 54. The suspension control module 56 is also in communication with the VMC module 58 via a communication channel 62. The suspension control module 56 receives the motion actuation settings from the VMC module 58 via the communication channel 62. The suspension control module 56 adjusts the suspension actuation settings and outputs the suspension actuation settings to the suspension actuator 26 via a suspension actuator connection 64a. The suspension actuation settings are also transmitted to the VMC module 58 via the communication channel 62.

The suspension control module 56 is further configured to measure the current value of one or more of the suspension actuation settings using the plurality of vehicle sensors 18, as discussed above in reference to block 116 of the method 100. The current value of one or more of the suspension actuation settings is provided to the coordinator module 54 via the second input 60b, as discussed above.

The VMC module 58 is configured to control the motion actuator 28 to adjust at least one of the motion actuation settings, as discussed above in reference to block 114 of the method 100. The VMC module 58 receives the vehicle level control parameters produced by the coordinator module 54. The VMC module 58 is also in communication with the suspension control module 56 via the communication channel 62. The VMC module 58 receives the suspension actuation settings from the suspension control module 56 via the communication channel 62. The VMC module 58 adjusts the motion actuation settings and outputs the motion actuation settings to the motion actuator 28 via a motion actuator connection 64b. The motion actuation settings are also transmitted to the suspension control module 56 via the communication channel 62.

The VMC module 58 is further configured to measure the current value of one or more of the motion actuation settings using the plurality of vehicle sensors 18, as discussed above in reference to block 116 of the method 100. The current value of one or more of the motion actuation settings is provided to the coordinator module 54 via the third input 60c, as discussed above.

In exemplary embodiment, the VMC module 58 is further configured to predict future conditions of the vehicle 12 based on the measurements from the plurality of vehicle sensors 18, as discussed above in reference to block 116 of the method 100. The predicted future conditions of the vehicle 12 are provided to the coordinator module 54 via the third input 60c, as discussed above.

It should be understood that the exemplary software architecture 50 is merely exemplary in nature. Any configuration of the system 10 or any other system suitable to perform the method 100 is within the scope of the present disclosure.

The system 10 and method 100 of the present disclosure offer several advantages. The system 10 and method 100 allow for increased vehicle stability, performance, and comfort through coordinated control of the suspension actuator 26 and the motion actuator 28. Additionally, because the vehicle level control parameters are determined based at least in part on the predicted path of the vehicle 12, the vehicle level control parameters may be optimized based on future conditions (i.e., future predicted location/path of the vehicle 12), allowing for dynamically optimized control which accounts for past, present, and predicted future conditions. As exemplified by the exemplary software architecture 50, the method 100 may be implemented using the system 10 in a modular fashion, allowing individual software modules to be designed and calibrated independently.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for control of a vehicle, the system comprising:
a plurality of vehicle actuators; and
a controller in electrical communication with the plurality of vehicle actuators, wherein the controller is programmed to:
determine a predicted path of the vehicle;
determine one or more vehicle level control parameters based at least in part on the predicted path of the vehicle, wherein the one or more vehicle level control parameters includes: a vehicle level suspension control parameter and a vehicle level motion control parameter;
adjust an operation of one or more suspension actuators of the plurality of vehicle actuators based at least in part on the vehicle level suspension control parameter; and
adjust an operation of one or more motion actuators of the plurality of vehicle actuators based at least in part on the vehicle level motion control parameter.

2. The system of claim 1, wherein to determine the predicted path of the vehicle, the controller is further programmed to:
determine the predicted path based at least in part on actions of an occupant of the vehicle.

3. The system of claim 1, further comprising a plurality of vehicle sensors and an automated driving system in electrical communication with the controller, wherein to determine the predicted path of the vehicle, the controller is further programmed to:
perform a plurality of measurements of an environment surrounding the vehicle using the plurality of vehicle sensors; and
determine the predicted path of the vehicle using the automated driving system based at least in part on the plurality of measurements, wherein the predicted path of the vehicle includes at least a location of the vehicle as a function of time.

4. The system of claim 1, wherein the vehicle level suspension control parameter includes at least one of: a stiffness mode, a driving mode, a ride height mode, and a load-leveling mode, and wherein the vehicle level motion control parameter includes at least one of: a propulsion setting and a steering setting.

5. The system of claim 4, wherein to adjust the operation of the one or more suspension actuators, the controller is further programmed to:
adjust at least one of one or more suspension actuation settings using the one or more suspension actuators based at least in part on the vehicle level suspension control parameter, wherein the one or more suspension actuation settings includes at least one of: a per-wheel damping force, a per-wheel spring force, a per-wheel ride height, a per-wheel travel, and a sway bar stiffness.

6. The system of claim 5, wherein to adjust the operation of the one or more motion actuators, the controller is further programmed to:
adjust at least one of one or more motion actuation settings using the one or more motion actuators based at least in part on the vehicle level motion control parameter, wherein the one or more motion actuation settings includes at least one of: a per-wheel drive torque, a per-wheel steering torque, and a per-wheel brake force.

7. The system of claim 6, wherein to adjust the operation of the one or more suspension actuators, the controller is further programmed to:
adjust at least one of the one or more suspension actuation settings using the one or more suspension actuators based at least in part on the vehicle level suspension control parameter and the one or more motion actuation settings.

8. The system of claim 6, wherein to adjust the operation of the one or more motion actuators, the controller is further programmed to:
adjust at least one of the one or more motion actuation settings using the one or more motion actuators based at least in part on the vehicle level motion control parameter and the one or more suspension actuation settings.

9. The system of claim 6, further comprising a plurality of vehicle sensors in electrical communication with the controller, wherein the controller is further programmed to:
measure a current value of the one or more suspension actuation settings using the plurality of vehicle sensors;
measure a current value of the one or more motion actuation settings using the plurality of vehicle sensors; and
determine the one or more vehicle level control parameters based at least in part on the current value of the one or more suspension actuation settings and the current value of the one or more motion actuation settings.

10. The system of claim 1, wherein the controller is further programmed to:
determine a suspension actuator capability range for each of the one or more suspension actuators;
determine a motion actuator capability range for each of the one or more motion actuators; and
determine the one or more vehicle level control parameters based at least in part on suspension actuator capability range for each of the one or more suspension actuators and the motion actuator capability range for each of the one or more motion actuators.

11. A method for control of a vehicle, the method comprising:
determining a predicted path of the vehicle;
determining one or more vehicle level control parameters based at least in part on the predicted path of the vehicle, wherein the one or more vehicle level control parameters includes: a vehicle level suspension control parameter and a vehicle level motion control parameter;
adjusting an operation of one or more suspension actuators based at least in part on the vehicle level suspension control parameter; and
adjusting an operation of one or more motion actuators based at least in part on the vehicle level motion control parameter.

12. The method of claim 11, wherein determining the one or more vehicle level control parameters further comprises:
determining the vehicle level suspension control parameter, wherein the vehicle level suspension control parameter includes at least one of: a stiffness mode, a driving mode, a ride height mode, and a load-leveling mode; and
determining the vehicle level motion control parameter, wherein the vehicle level motion control parameter includes at least one of: a propulsion setting and a steering setting.

13. The method of claim 12, wherein adjusting the operation of the one or more suspension actuators further comprises:
adjusting at least one of one or more suspension actuation settings using the one or more suspension actuators based at least in part on the vehicle level suspension control parameter, wherein the one or more suspension actuation settings includes at least one of: a per-wheel damping force, a per-wheel spring force, a per-wheel ride height, a per-wheel travel, and a sway bar stiffness.

14. The method of claim 13, wherein adjusting the operation of the one or more motion actuators further comprises:
adjusting at least one of one or more motion actuation settings using the one or more motion actuators based at least in part on the vehicle level motion control parameter, wherein the one or more motion actuation settings includes at least one of: a per-wheel drive torque, a per-wheel steering torque, and a per-wheel brake force.

15. The method of claim 14, wherein adjusting the operation of the one or more suspension actuators further comprises:
adjusting at least one of the one or more suspension actuation settings using the one or more suspension actuators based at least in part on the vehicle level suspension control parameter and the one or more motion actuation settings.

16. The method of claim 14, wherein adjusting the operation of the one or more motion actuators further comprises:
adjusting at least one of the one or more motion actuation settings using the one or more motion actuators based at least in part on the vehicle level motion control parameter and the one or more suspension actuation settings.

17. The method of claim 11, further comprising:
determining a suspension actuator capability range for each of the one or more suspension actuators;
determining a motion actuator capability range for each of the one or more motion actuators; and
determining the one or more vehicle level control parameters based at least in part on suspension actuator capability range for each of the one or more suspension actuators and the motion actuator capability range for each of the one or more motion actuators.

18. A system for control of a vehicle, the system comprising:
a suspension actuator;
a motion actuator; and
a controller in electrical communication with the suspension actuator and the motion actuator, wherein the controller is programmed to:
determine a predicted path of the vehicle based at least in part on actions of an occupant of the vehicle;
determine a vehicle level suspension control parameter based at least in part on the predicted path of the vehicle;
determine a vehicle level motion control parameter based at least in part on the predicted path of the vehicle;
adjust at least one of one or more suspension actuation settings using the suspension actuator based at least in part on the vehicle level suspension control parameter, wherein the one or more suspension actuation settings includes at least one of: a per-wheel damping force, a per-wheel spring force, a per-wheel ride height, a per-wheel travel, and a sway bar stiffness; and
adjust at least one of one or more motion actuation settings using the motion actuator based at least in part on the vehicle level motion control parameter, wherein the one or more motion actuation settings includes at least one of: a per-wheel drive torque, a per-wheel steering torque, and a per-wheel brake force.

19. The system of claim 18, wherein the controller is further programmed to:
adjust at least one of the one or more suspension actuation settings using the suspension actuator based at least in part on the vehicle level suspension control parameter and the one or more motion actuation settings; and
adjust at least one of the one or more motion actuation settings using the motion actuator based at least in part on the vehicle level motion control parameter and the one or more suspension actuation settings.

20. The system of claim 19, further comprising a plurality of vehicle sensors in electrical communication with the controller, wherein the controller is further programmed to:
measure a current value of the one or more suspension actuation settings using the plurality of vehicle sensors;
measure a current value of the one or more motion actuation settings using the plurality of vehicle sensors; and
determine the vehicle level suspension control parameter and the vehicle level motion control parameter based at least in part on the current value of the one or more suspension actuation settings and the current value of the one or more motion actuation settings.
